(19) United States
(12) Patent Application Publication
(10) Pub. No.: US 2010/0332352 A1
(43) Pub. Date: Dec. 30, 2010

(54) ELECTRONIC TASTING ROOM FOR FOODS AND BEVERAGES AND DISTRIBUTION THEREOF

(75) Inventor: Timothy Bucher, Geyserville, CA (US)

Correspondence Address: Workman Nydegger;1000 Eagle Gate Tower, 60 East South Temple, Salt Lake City, UT, 84111, US

(73) Assignee: TASTING ROOM, INC., Los Altos, CA (US)

(21) Appl. No.: 12/823,782

(22) Filed: Jun. 25, 2010

Related U.S. Application Data
(60) Provisional application No. 61/220,479, filed on Jun. 25, 2009.

(51) Int. Cl. G06Q 30/00

(52) U.S. Cl. 705/27

(57) ABSTRACT

An electronic sampling system for providing a sample of a product from a producer to a customer which includes a producer interface capable of communicating with the producer and requesting a quantity of product from the producer, a user interface capable of communicating with the user in order to show the user a listing of producers and samples that are available for distribution and receive requests from the user samples which are prepared by an operations center capable of receiving the quantity of product from the producer and sending the requested sample of the product to the user.

### CROSS-REFERENCE TO RELATED APPLICATIONS

This application claims the benefit of U.S. Provisional Patent Application Ser. No. 61/220,479, filed Jun. 25, 2009, entitled “Electronic Tasting Room for Foods and Beverages and Distribution Thereof,” which is incorporated herein by reference.

### BACKGROUND OF THE INVENTION

1. The Field of the Invention

The present invention relates to a system and method for providing users with samples of foods and beverages. More specifically, the present invention relates to a system and method for allowing users to request samples of foods and beverages from a plurality of producers and distributors.

2. The Relevant Technology

As the number and variety of food and beverage products that are available to consumers today have increased, many manufactures and producers have developed sampling programs whereby potential customers are given a sample of the product in order to acquaint the consumers with their products. In many instances, the samples are offered as a marketing tool for free or at a reduced price. One benefit of these sampling programs is that it encourages potential customers to try new products without requiring a significant investment. Thus, consumers are benefitted by getting the opportunity to try the product with little or no risk and producers and manufacturers are benefitted by increased exposure of their product to consumers, which often results in increased sales.

In other industries, such as the wine and cheese industry, where the final product may vary vastly from one producer to another, depending on the specific materials used in the production process, the area where it was produced, the age of the product, and the like, the sheer variety of products available on the market has resulted in an entire culture centered around examining or evaluating the products in a “tasting” or “sampling” process. In order to facilitate this process, many wine producers in wine regions all over the world offer tastings of their wine. Depending on the country or region, tasting at the winery may incur a small charge to allow the producer to cover costs. Typically, however, traveling to particular wineries or producers to sample the product where it is produced is impractical. Thus, consumers often rely on professional tasters and rating systems for guidance in selecting a product. One problem with this process, however, is that despite the subjective nature of the product, consumers often must rely on the recommendations of professional rating systems, rather than sampling the product themselves given that everyone's palate is unique. Further, producers are limited in their ability to distribute their products to a wide array of consumers. Thus, there is a need for a new distribution system and method that provides producers and distributors with the ability to distribute their products to consumers.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to systems and methods for providing and distributing samples of a product to a customer. More specifically, embodiments of the invention provide a system and method for enabling a producer of a product to distribute samples of their product to customer who have requested the samples.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Embodiments of the invention are directed to an electronic sampling system for providing a sample of a product from a producer to a customer. In one aspect of the invention, the system comprises a producer interface capable of communicating with the producer and requesting a quantity of product from the producer, a user interface capable of communicating with the user, providing the user with a listing of producers and samples that are available for distribution, and receiving a request from the customer for a sample of the product from the producer, and an operations center capable of receiving the quantity of product from the producer and sending the requested sample of the product to the customer.

Another aspect of the invention is a method for providing a sample of a product to a user in an electronic sampling system including an operations center and a computer with a database, a server, a producer interface for communicating with a producer of the product, and a user interface for communicating with the user. The method comprises providing the user with a listing of producers and samples that are available for distribution through the user interface, receiving a request from the customer for a sample of the product from the producer through the user interface, communicating with the producer via the producer interface and requesting a quantity of the product from the producer, receiving the quantity of product from the producer at the operations center, and sending the requested sample of the product from the operations center to the customer.

A third aspect of the invention comprises an electronic sampling system for providing a sample of a product from a producer to a user including a computer with a processor, database for storing tangible, computable readable data, and a server. The system comprises a producer interface for communicating with a plurality of producers of products via the processor in order to receive a request to include a request from a plurality of producers to include products from the plurality of producers in the system, the producer interface also being able to request a quantity of product from each of the plurality of producers, a product description listing stored in the database which describes each of the producers and samples that are available for distribution, a user interface for communicating with the user, providing the user with the product description listing, and receiving a request from the customer for a sample of a product from a particular producer, an operations center for receiving the quantity of product from the particular producer and packaging the requested sample of the product, and a mailing center for sending the requested sample of the product to the customer.

As is described more fully below, the aspects of the invention provide a mechanism for producers of products to offer samples of their products to potential customers without requiring the producers to prepare and market the samples themselves. As may be understood, this provides additional marketing and distribution opportunities which are not currently available in the art.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an electronic tasting system capable of performing aspects of the invention;

FIG. 2 illustrates an embodiment of the electronic tasting system of the present invention; and

FIG. 3 is a block diagram illustrating a method of the present invention.

### DETAILED DESCRIPTION OF THE PREFERRED EMBODIMENTS

Embodiments of the invention relate to a system and method for providing an electronic tasting room and distribution model for foods and beverages. More specifically, the present invention provides a mechanism whereby producers of food and beverage products are capable of distributing samples of their products to consumers. As described more fully below, aspects of the invention use an online user interface which allows consumers to request samples of products from the producers, rather than depending on the three or four tier distribution models that are currently used in the art today. One benefit of aspects of the invention is allowing consumers to try the products for themselves before investing the additional cost required to purchase the larger quantities typically sold. Further, aspects of the invention allow producers to distribute their products to a wider variety of consumers in an efficient and reliable way, providing the producers with the opportunity to broaden their distribution market and increase sales.

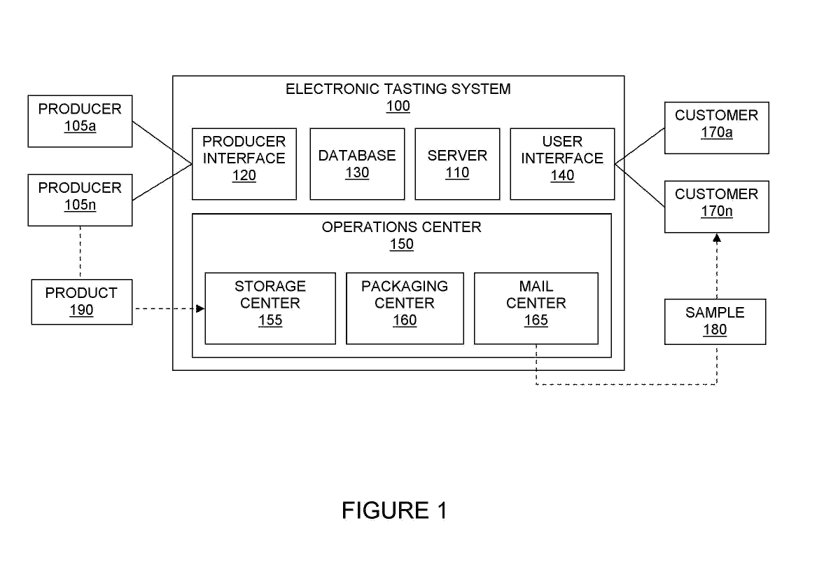

FIG. 1 is a block diagram that illustrates an environment capable of performing aspects of the invention. As shown in FIG. 1, aspects of the environment provide an electronic tasting or sampling system 100 which includes server 110 for sending and receiving communications in a network, a database 130 where data associated with the system 100 may be stored, a producer interface 120 whereby producers 105a-105n are capable of communicating with the system 100, a user interface 140 whereby customers 170a-170n are capable of communicating with the system, and an operations center 150. Using the producer interface 120, producers 105a-105n may connect to the electronic tasting system 110 and create a profile and account with the system 100, whereby the producer 105a may distribute samples of his or her products. In one embodiment of the invention, this may include creating a description of the product and establishing the cost, if any, of receiving a sample of the product.

During this process, the electronic tasting system 100 may perform a variety of authentication processes, including a process whereby a system administrator reviews the producer's 105a and makes a determination as to whether the producer 105a should be allowed to distribute their product through using the electronic tasting system 100. This process may include verifying the identity of the producer, receiving a sample of the product, testing the product, verifying the information supplied to the system 110 by the producer 105a, and the like.

Once the producer 105a has been approved by the authentication process, the producer 105a is included as an authorized vendor in the database 130 of the electronic tasting system 100 and is listed in the user interface 140 as a producer of a sample that is available for purchase or distribution. As described more fully below, the user interface 140 enables customers 170a-170n to browse through a directory or listing of available samples 180 in order to identify products that he or she wishes to receive. In some instances these samples may be free, while in other instances, the samples may be associated with a price in order to offset the cost of producing and distributing the samples. Further, in one embodiment, the customers 170a-170n may be charged a flat or periodic fee for using the electronic tasting system 100.

As may be understood by one of ordinary skill in the art, the user interface may include any number of interface elements currently used in the art, including images, selection tools, shopping carts, text, interactive features and the like. In one embodiment, the online user interface may be configured so that consumers can browse through a directory of samples and select on samples they'd like to receive, by creating a number of selections, making a payment (if necessary) and entering an address where the sample may be sent.

As may be understood by one of ordinary skill in the art, the user interface may include any number of interface elements currently used in the art, including images, selection tools, shopping carts, text, interactive features and the like. In one embodiment, the online user interface may be configured so that consumers can browse through a directory of samples and select on samples they'd like to receive, by creating a number of selections, making a payment (if necessary) and entering an address where the sample may be sent.

In another embodiment, consumers may rate the samples they've received in the past. This rating may be used to create a recommendation system of other items that the consumer may enjoy based on all the ratings a consumer has made in the past. In addition, the user's reviews or rankings may be added to being added to an overall ranking of the product by all users of the system. Hence, when a user browses through the directory, he or she may be presented with reviews or rankings by other users of the system.

In another embodiment, the system 100 may automatically create reservations of samples for a user based on their previously rated or requested samples. For example, if a user has previously requested samples of products from a particular producer and has given those products a high ranking or has eventually ordered full-sized products from that producer, the system may determine that the user is likely to be interested in other products from that producer and automatically add samples of other products from that producer or other related producers to a queue, cart, or other requesting mechanism of the user. The user may then have the opportunity to review their queue or cart before finalizing their requests.

When a customer 170n has selected a sample 180 from a producer 105n, the system 110 may send a communication to the producer 105n requesting that a quantity of the product 190 be sent to the operations center 150 of the electronic tasting system. Alternatively, the operations center 150 may maintain an inventory of products and samples so that the samples may be sent to the customers 170a-170n more quickly.

As may be understood by one of ordinary skill in the art, one advantage of the operations center 150 of the electronic tasting system 100 according to one embodiment of the invention is that the operations center 150 may be configured to receive quantities of the product 190 of a different size than the sample size 180 sent to the customers 170a-170n. More specifically, the operations center 150 may include a storage center 155 where large quantities of the product 190 may be stored and repackaged in a packaging center 160 into smaller sample-sized quantities 180. One advantage of this configuration is that the producer 105n is not required to modify their existing operations. Thus, the producers 105a may negotiate with the electronic tasting system 100 as to how much product the tasting system 100 is willing to or capable of storing in the storage center 155.

Upon receiving the request from the customer 170a, the packaging center 160 directs a sample 180 of the requested product to the mail center 165, where the sample 180 is adequately addressed and shipped to the customer 170n. In one embodiment of the invention, this system may include various automated processes, including the use of barcodes and other mechanisms which enable the tracking of the sample 180. For example, an automated email or other communication may be sent to the customer 170n, notifying them that their sample 180 has been sent, along with the tracking information of the mail service, which the customer 170n may use to track the shipment. Alternatively, the user interface 150 may include a tracking section where the customer 170n may review the status of his or her ordered samples 180.

In one embodiment of the invention, the electronic system 100 may receive a portion of the receipts for the sales of the samples 180 sent to the customers 170n, if any. One advantage of this configuration is that the producers 105a-105n are only required to pay for the electronic tasting system 100 if the system 100 produces sales.

Although the tasting system 100 described in FIG. 1 may be applied to any number of different industries, including those where a variety of different foods and beverages from different types of producers 105a-105n are sold and packaged together. In this embodiment, the various producers 105a-105n may each send a quantity of their products 190 to the operations center 150, where the products 190 may be stored at the storage center 155 and repackaged at the packing center 160 for shipment to customers 170a-170n.

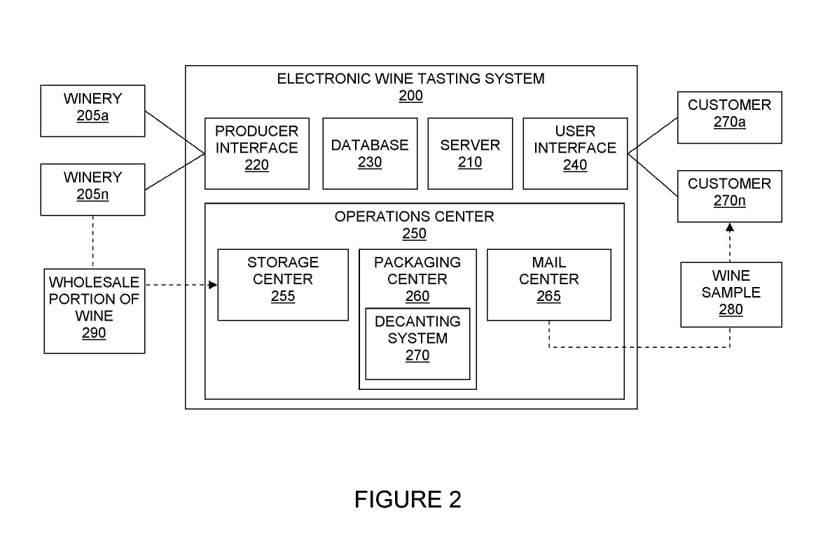

FIG. 2 is a block diagram illustrating an embodiment of the invention where an electronic wine tasting system 200 is used to distribute samples or “glasses” of wine may be distributed to customers 270a-270n. In this example, a series of wineries 205a-205n connect to the system 200 using a producer interface 220. Similarly, the system 200 may send communications to the wineries 205a-205n, such as requests for additional quantities of wine, using the producer interface. Alternatively, the system 200 may initiate payments to the wineries 205a-205n, if any, using the producer interface 220.

The wineries 205a-205n may then sends a wholesale portion of wine 290 to the operations center 250 of the tasting system 200. As previously described, one advantage of embodiments of the invention is that the winery 205n may send any quantity to the operations center 250 for distribution, depending on the specific agreement between the tasting system 200 and the winery 205n. Thus, the wholesale portion of wine 290 sent to the operations center 250 may comprise any bottle size or other container, including commonly produced quantities of 750 ml bottles, magnums, barrels, boxes, and the like.

In this configuration, the wholesale portions of wine 290 may be stored at the storage center 255 and repackaged into samples or “glasses” of wine at the packaging center 260. In one embodiment, the packaging center 260 may include a decanting system 270 where the wholesale portions of wine 290 may be decanted under inert environmental conditions prior to sending the samples 280 to the customers 270a-270n. In one embodiment of the invention, the system may decant the portions of wine 290 into 50 ml containers of wine which are then distributed as samples 280 or “glasses” of wine.

In one embodiment, the portions of wine 290 may be tested for chemical composition by the operations center 250. The results of the test may be stored in the database 230.

As in FIG. 1, customers may connect to a user interface 240 via a sever 210 in order to browse through a listing of wine samples 280 that are available for distribution through the electronic wine tasting system 200. In one embodiment, the results of the chemical composition testing may be displayed to users in the user interface 240 in order to assist customers 270a-270n in making their selections. The results may also be used in a recommendation system, wherein a customer's previous positive rating of a sample of a first composition may be used to predict that the same customer will enjoy a second sample which has a composition similar to the previous sample.

As may be understood by one of ordinary skill in the art, one advantage of the wine tasting system 200 described herein is in direct sales for wineries 205a-205n. Currently, wineries enjoy the greatest profit margins through sales in their local tasting rooms and wine clubs, rather than relying on the three or four-tier distribution models that are typically used to distribute wine. Using the system and method described herein, wineries may broaden their direct sales and distribution models. This may result in higher profits to the wineries, without requiring the wineries to modify their current production and packaging processes.

Further, embodiments of the invention provide customers with a user interface that enables consumers with the ability to browse and select wine samples so that wine tastings can be done in the comfort of the consumer's own home. More specifically, embodiments enable users to browse and identify wine samples from all over the world that they would like to sample. In some instances, the user interface may include online “tasting rooms” or collections of featured wines that the user may elect to receive for sampling. One advantage of that users may create their own wine tasting parties, regardless of their location. Thus, customers may sample a wider variety of goods and products from the comfort of their own home. Thus, embodiments of the invention provide a positive out-of-the-box experience, wherein users are able to participate in an interactive sampling and feedback community.

Another advantage of this configuration is that wineries are able to generate direct sales, expand business with little-to-no additional costs, and receive direct feedback from a wide variety of customers 270a-270n. Over time, wineries may be able to reduce distribution costs and modify the existing economic model currently used in the art today.

Further, embodiments may enable wineries and other producers to expand their sales into new areas of business, including direct sales of smaller sizes or samples, futures contracts, bundles with other types of food or products, and merchandising and promotional opportunities. Further, the electronic user interface 240 may be integrated with other areas of the internet, including social networks, blogs, Twitter, and the like. As may be understood by one of ordinary skill in the art, one advantage of integrating with other online sites is the ability to reach a younger demographic of customers who are more likely to use the Internet to shop and communicate.

As previously described, a variety of different pricing models may be used in association with the present invention. More specifically, in one embodiment, producers may each set the price for their own goods. In one model, the producers may elect to lose money on the production and distribution of samples, by offering the samples for free or at a loss, in an attempt to recoup money on sales and increased volume. In other model, the producers may elect to sell the samples at a price so as to break-even on production and distribution costs. In this embodiment, the producers may protect themselves from losing money by offering samples, while potentially increasing the number of sales. In another pricing model, the producer may sell the samples at a profit.

In one embodiment, the user interface 240 may be used in association with an existing club or product recommendation system, including a “wine of the month club” and the like. Using this configuration, the operator of the “wine of the month club” may identify a selection of wine or other products for distribution to a subscription list. Depending on the specific pricing configuration used, the operator of the club may give the tasting system 200 a fee or royalty for using the system 200. Similarly, the system 200 may allow subscribers of the club to order samples from the selected list for no charge, since the subscribers may pay the club a fee for use of the service.

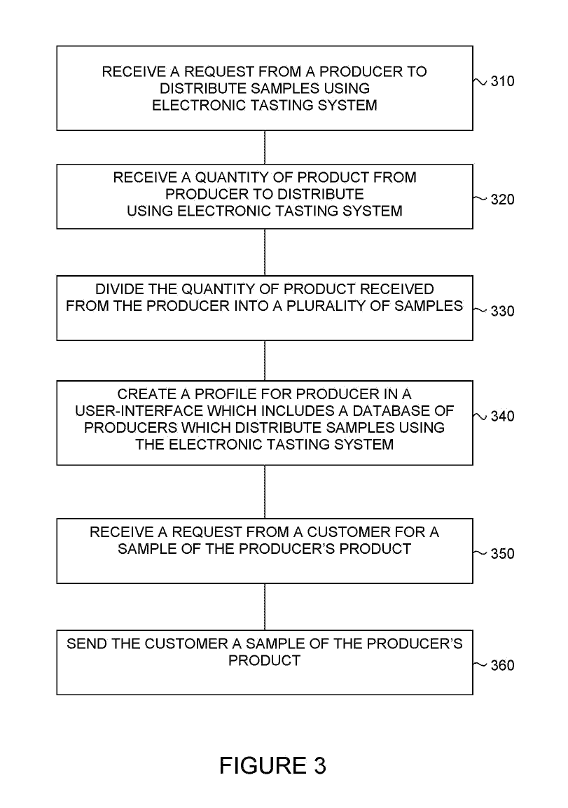

FIG. 3 illustrates a method of the invention. As previously described, the method begins when the electronic tasting system receives 310 a request from a producer to distribute samples of the producer's product using the electronic tasting system. Then, the system receives 320 a quantity of product from the producer for distributing using the electronic tasting system. This quantity is divided 330 into a plurality of samples. The system creates 340 a profile for the producer in the user-interface which includes a database of producers which distributes samples using the system. Once the profile is available in the user-interface, the system receives 350 a request from a customer for a sample of the producer's product. Then, the system sends 360 the customer a sample of the producer's product.

In the above description, the system receives a quantity of product from the producer and divides the quantity into a plurality of samples prior to the producer's profile being included in the database of producers in the user interface. These steps need not be performed in this order, and in an alternative embodiment, the producer profile may be created and added to the database prior to the system receiving a quantity of product from the producer. One advantage of using this embodiment, is that the quantity of product does not need to be stored prior to the receipt of a request from a customer for a sample. One disadvantage, however, is that there is additional delay in delivering the sample to the customer since the system must first receive the product from the producer before it may be sent to the customer.

As previously described, embodiments of the invention provide a system and method for producers to distribute a plurality of samples to a variety of customers using an integrated system which is capable of enabling distribution of goods from the producers to customers. As previously described, the system and method includes a user interface where users may browse and select goods which they desire to sample from a listing of available samples. By providing an interface which may be used by both producers and consumers, the system and method described herein enable producers to send samples to consumers and potential customers in a direct manner, without relying on the existing distribution methods currently used in the art.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An electronic sampling system for providing a sample of a product from a producer to a user, the system comprising:
a producer interface for communicating with the producer and requesting a quantity of product from the producer;
a user interface for communicating with the user, providing the user with a listing of producers and samples that are available for distribution, and receiving a request from the customer for a sample of the product from the producer; and
an operations center for receiving the quantity of product from the producer and sending the requested sample of the product to the customer.

2. The electronic sampling system of claim 1, wherein the product is a food product.

3. The electronic sampling system of claim 1, wherein the product is an alcoholic beverage.

4. The electronic sampling system of claim 1, wherein the operations center further comprises a storage center for storing the quantity of product received from the producer.

5. The electronic sampling system of claim 4, wherein the quantity of product received from the producer comprises a wholesale quantity of the product which is received by the operation center and stored in the storage center until the wholesale quantity of the product is repackaged at a packaging center of the operations center into samples for distribution.

6. The electronic sampling system of claim 5, wherein the product is an alcoholic beverage, the wholesale quantity of the product is one or more bottles of greater than 700 milliliters, and wherein the packaging center further comprises a decanting system for decanting the wholesale quantity into samples of between 25 and 100 milliliters.

7. The electronic sampling system of claim 1, wherein the user interface further includes a recommendation system for recommending samples of product to the user.

8. A method for providing a sample of a product to a user in an electronic sampling system including an operations center and a computer with a database, a server, a producer interface for communicating with a producer of the product, and a user interface for communicating with the user, the method comprising:
providing the user with a listing of producers and samples that are available for distribution through the user interface;
receiving a request from the customer for a sample of the product from the producer through the user interface;
communicating with the producer via the producer interface and requesting a quantity of the product from the producer;
receiving the quantity of product from the producer at the operations center; and
sending the requested sample of the product from the operations center to the customer.

9. The method of claim 8, wherein the product is a food product.

10. The method of claim 8, wherein the product is an alcoholic beverage.

11. The method of claim 8, wherein the operations center includes a storage center for storing the quantity of product received from the producer.

12. The method of claim 11, wherein receiving the quantity of product from the producer comprises receiving a wholesale quantity of the product at the operation center and storing the wholesale quantity of the product in the storage center, repackaging the wholesale quantity of the product at a packaging center of the operations center into requested samples for distribution.

13. The method of claim 12, wherein the product is an alcoholic beverage, the wholesale quantity of the product is one or more bottles of greater than 700 milliliters, and wherein sending the requested sample of the product further comprises decanting the wholesale quantity into a requested sample of between 25 and 100 milliliters.

14. The method of claim 12, further comprising recommending samples to the user via the user interface.

15. An electronic sampling system for providing a sample of a product from a producer to a user including a computer with a processor, database for storing tangible, computable readable data, and a server, the system comprising:
a producer interface for communicating with a plurality of producers of products via the processor in order to receive a request to include a request from a plurality of producers to include products from the plurality of producers in the system, the producer interface also being able to request a quantity of product from each of the plurality of producers;
a product description listing stored in the database which describes each of the producers and samples that are available for distribution;
a user interface for communicating with the user, providing the user with the product description listing, and receiving a request from the customer for a sample of a product from a particular producer;
an operations center for receiving the quantity of product from the particular producer and packaging the requested sample of the product; and
a mailing center for sending the requested sample of the product to the customer.

16. The electronic sampling system of claim 15, wherein the product is a food product or beverage.

17. The electronic sampling system of claim 15, wherein the operations center further comprises a storage center for storing product from the plurality of producers.

18. The electronic sampling system of claim 17, wherein the quantity of product received from the particular producer comprises a wholesale quantity of the product which is received by the operation center and stored in the storage center until the wholesale quantity of the product is repackaged at a packaging center of the operations center into the requested sample.

19. The electronic sampling system of claim 18, wherein the product is an alcoholic beverage, the wholesale quantity of the product is one or more bottles of greater than 700 milliliters, and wherein the packaging center further comprises a decanting system for decanting the wholesale quantity into samples of between 25 and 100 milliliters.

20. The electronic sampling system of claim 15, wherein the user interface further includes a recommendation system for recommending samples of product to the user.
